(19) United States
(12) Patent Application Publication
(10) Pub. No.: US 2014/0272801 A1
(43) Pub. Date: Sep. 18, 2014

(54) LAB ANALOG WITH INDEXING FOR INSERTION INTO PLASTIC MODELS WITH CORRESPONDING COUNTER-INDEXING

(71) Applicant: Heraeus Kulzer GmbH, Hanau (DE)

(72) Inventor: Norbert Ueberück, Bruchkobel (DE)

(21) Appl. No.: 14/348,914

(22) PCT Filed: Sep. 27, 2012
(86) PCT No.: PCT/EP2012/004043

§ 371 Date: May 30, 2014

(30) Foreign Application Priority Data
Oct. 7, 2011 (DE) 10 2011 115 031.9

(51) Int. Cl. A61C 13/34; A61C 13/08; A61C 9/00

(52) U.S. Cl. CPC A61C 13/34; A61C 9/004; A61C 13/08
USPC 433/213

(57) ABSTRACT

The invention relates to a method for producing a three-dimensional model of at least a part of a jaw in order to produce a dental prosthesis, wherein a laboratory implant is arranged in a recess of the model, a cylindrical or conical recess being produced in the model according to the method, the laboratory implant being inserted into the recess in order to position the laboratory implant on the model, wherein the recess is produced with a single or multiple rotational symmetry about the longitudinal axis of the recess, and a laboratory implant is used that has the same rotational symmetry at least in certain areas and thus fits into the recess, or a counter thread mating with a thread on the lab implant is produced in the recess. The invention also relates to a model of a jaw for the production of a dental prosthesis, in particular to the conducting of such a method, the model comprising a recess for insertion of a laboratory implant, the recess being shaped cylindrically or conically and having a single or multiple rotational symmetry along the longitudinal axis, so that a laboratory implant with identical rotational symmetry, at least in certain sections, can be arranged in a rotationally fixed manner in the recess, or a counter-thread, preferably with a stop, is provided in the recess, said counter-thread mating with a thread on the laboratory implant, preferably with a stop, so that the laboratory implant can be arranged in a fixed position in the model. The invention further relates to a laboratory implant for the production of a dental prosthesis, in particular to the conducting of such a method, the laboratory implant comprising an area for insertion into a recess of a jaw model and a head part for mounting the dental prosthesis, the laboratory implant being cylindrical or conical, at least in certain sections, and having a single or multiple rotational symmetry about its longitudinal axis, so that the laboratory implant can be arranged in a rotationally fixed manner in a recess with a matching shape, or comprising an outside thread, preferably an external thread with a stop, so that the laboratory implant can be arranged in a fixed position in a recess having mating internal thread. Finally the invention also relates to a device for producing a model of a jaw for realizing such a method.

This application is a 371 of PCT/EP2012/004043 filed Sep. 27, 2012, which claims priority to Germany application 10 2011 115 031.9 filed Oct. 7, 2011.

The invention relates to a method for producing a three-dimensional model of at least a partial area of a jaw for producing a dental prosthesis in which lab analog is arranged in a recess in the model.

The invention also relates to a model of a jaw for producing a dental prosthesis, in particular for performing such a procedure including a recess for insertion of a lab analog; as well as a lab analog for producing a dental prosthesis, in particular for performing such a procedure, comprising a region for insertion into a recess in a model of a jaw and a head part for creation of the dental prosthesis.

Finally, the invention also relates to a device for producing a model of a jaw for implementation of such a method.

### BACKGROUND OF THE INVENTION

Dental implants are used in dentistry to replace teeth that have been extracted or have fallen out. To do so, the dental implants are inserted into the jawbone. DE 10 2007 029 105 A1, a family member of US 2010/0304337 A1, discloses dental implants, which include a post part that is inserted into the jawbone and a mounting part on which the dental prosthesis is mounted. The post part and the mounting part are connected with a screw. Furthermore, the post part and the mounting part are structured with indexing, which should prevent the mounting part from being insertable in any angles into the post part.

Lab analogs are required to provide a dental technician with an opportunity to model in the laboratory a dental prosthesis which is then later inserted into the patient. Lab analogs therefore have a material-specific geometry and shape. In most cases, an impression is made using a impression material with which a plaster model of the patient's jaw is then prepared by casting the impression with plaster. The lab analog is then inserted into the model of the patient's jaw in the proper position. The geometry and shape of the lab analog must therefore be adapted to the plaster. Undercuts into which the liquid plaster can flow are therefore provided in some cases, so that after the lab analog has hardened, the shapes formed by these undercuts will hold the lab analog in the proper position. Such a lab analog according to the prior art is diagrammed in a schematic cross section in FIG. 1. This model of the jaw with the integrated lab analog is used by the dental technician to shape the dental prosthesis to adapt to the situation in the patient's oral cavity.

For some time now, instead of this method, another method has been used to provide a model for the jaw and the installation situation. Using the method of stereolithography, the three-dimensional situation in the patient's oral cavity is first recorded and then saved digitally in an electronic computer memory. Mostly CAD programs are used for this purpose. Then a model of the jaw is constructed in the known way using a light-curing plastic with the help of a laser. Then the lab analogs, which can also be used for the plastic model, are inserted into this plastic model of the jaw. The plastic model of the jaw may then be used again for mounting of the dental prosthesis by the dental technician.

In both cases, a lab analog comprising a cylindrical region with a circular cross section is inserted into the model of the jaw. Undercuts may be provided in the cylindrical region. The dental prosthesis is formed on the top side of the lab analog. The cylindrical region is inserted into a corresponding recess in the model of the jaw. The head part of the lab analog is shaped like the head of the mounting part of the dental implant, which is then inserted directly into the patient's mouth. This ensures that the dental prosthesis will accurately fit the head of the dental implant.

The disadvantage of this is that the installation situation on the model of the jaw is not precisely defined for the dental technician. Thus, on insertion of the dental prosthesis by the dentist, it may happen that the dental prosthesis does not exactly fit the situation in the patient's oral cavity. Then the dentist must adjust the dental prosthesis in situ or, in the worst case, a completely new dental prosthesis has to be fabricated again The lab analog also cannot readily be fixed in the correct position, so that position changes and thus a defective dental prosthesis may arise even during the manufacture of the dental prosthesis. The lab analog is rotatably and in the longitudinal direction movably arranged in the model.

The object of the invention is thus to overcome the disadvantages of the prior art. In particular a possibility is to be found for producing a dental prosthesis with the help of a model of the jaw, in particular a plastic model prepared by stereolithography with the greatest possible accuracy, so that there are fewer rejects in the production of a dental prosthesis and the dentist need not make as many additional adjustments, preferably none at all, when inserting the dental prosthesis. Furthermore, it should be possible to use modern methods in production of the model of the jaw. At the same time, however, as many as possible of the dental implants should be applicable, which are currently available on the market. A method and suitable equipment for implementing the method are to be made available.

### SUMMARY OF THE INVENTION

The object of the invention with respect to the method is achieved by the fact that a cylindrical or conical recess is created in the model, into which the lab analog is inserted to position the lab analog on the model, wherein the recess is created with a single-point rotational symmetry or multi-point rotational symmetry about the longitudinal axis of the recess, and a lab analog having the same rotational symmetry in at least some regions is used so that it fits into the recess, or an opposing thread which fits the thread on the lab analog is created in the recess.

### DETAILED DESCRIPTION

A cylindrical geometry in the present case is understood to be a cylindrical body having any desired base face. A conical symmetry in the present case is not only to be understood as a cone but also to include all geometries in which the region tapers from the head part to the mounting of the dental prosthesis. A steady taper is not the prerequisite for conical symmetry in the sense of the present invention but it is preferable according to the invention because such lab analogs can be introduced better into the recesses in the model of the jaw. Furthermore, additional structures such as lock-in-positions, undercuts and/or roughening, for example, may be provided on the surface of the regions of the lab analog, which, strictly speaking, break the cylindrical or conical symmetry. The recesses with a mating thread are preferably cylindrical with a circular base face and are designed for use of lab analogs with a circular cylindrical region and with a fitting thread.

The longitudinal axis of the recess is the axis along which the lab analog can be inserted into and removed from the recess. It usually lies on the mid-axis of the recess. The cylindrical or conical basic shape can predetermine the axis of symmetry. In the case of the single-point axis of rotational symmetry, it refers to the single-point axis of rotational symmetry, which coincides with the axis of rotational symmetry of the conical or cylindrical basic shape. In most cases, a cylindrical or conical shape is selected here for the basic shape of the region of the implant and thus of the recess, with which the symmetry of this basic shape is interrupted by grooves, indentations or protrusions. The axis of rotational symmetry of the basic shape is therefore to be understood as the axis of symmetry.

It may be stipulated that the dental prosthesis is mounted on a head part of the lab analog or on an abutment of the lab analog as the last step of the method.

In the method according to the invention, it is preferably also possible to provide that a computer is used for producing the recess, preferably the model with the recess, in particular a digitization of the patient's oral cavity, where the shape of the recess is read out of a computer memory unit, and in particular shapes, which fit the various lab analogs are assigned to the recesses, which are preferably selected by computer and/or by a user by using an input unit.

When using a computer to produce the model this yields the special combination effect that all the data for producing the model is already saved in the computer and therefore the surface of the model is saved there. The surface of the model of the jaw then need only be modified in such a way that the recess, which fits the lab analog that is most suitable or has been selected in advance by computer or is the only one saved, is now located at the proper location. The model can then be constructed with the modified surface, i.e., can be constructed together with the fitting recess.

It is also possible to provide that a lab analog having the same rotational symmetry as the recess, at least in some areas along its longitudinal axis, is used, and it preferably fits exactly into the recess or its thread fits exactly with the counter thread of the receptacle.

In the use of such a lab analog, it is certain that the recess will fit the region of the lab analog and therefore the lab analog is fixed well in the model.

Furthermore, it is possible to provide that a CAD-assisted stereolithographic method is used to produce the model and the model is preferably made of plastic, especially preferably a light-curing plastic.

Such methods are suitable in particular for implementing the methods according to the invention, because the recesses can in this way be integrated into the models of the jaw very well and without any great computation effort using simple and readily obtainable computers.

It is possible to provide that in producing the model a fixedly predefined shape is preseted for the recess, which fits with a certain lab analog and/or a shape is selected for the recess from a plurality of different shapes, which fit with the plurality of different lab analogs, the shape being integrated into a measured, virtual, digitized model of the jaw as a recess prior to producing the model.

In this way, a particularly user-friendly and/or variable method can be designed. The strength of the invention can be profitably implemented in particular with such possibilities.

Another embodiment of the invention may provide that the lab analog is introduced in a form-fitting manner into the recess, preferably being plugged in or screwed in and/or engaging with a lock-in-position in a mating lock-in-position in the recess. A rotationally fixed and/or positionally fixed arrangement of the lab analog in the model is achieved in this way in particular, and therefore there is the possibility of mounting a high-quality dental prosthesis.

It is also possible to provide that the model and the recess are produced in one step, the external shape of the model preferably being produced on the basis of a measurement on the patient and the shape of the recess being certain predefined.

The elimination of an additional working step saves on costs and time in production.

Furthermore, it is possible according to the invention to provide that a mating thread with a stop which fits with a thread on the lab analog is created in the recess, wherein the thread of the lab analog preferably also comprises a stop.

This measure also serves to better positioning and fixation of the lab analog.

The object of the invention is also achieved by a model of the jaw for producing a dental prosthesis, in particular for performing such a method, comprising a recess for insertion of a lab analog, in which the recess is cylindrical or conical in shape and has a single-point or multi-point axis of rotational symmetry along the longitudinal axis, so that a lab analog having the same rotational symmetry in at least some regions is to be arranged in a rotationally fixed manner in the recess or a mating thread, preferably with a stop being provided in the recess, said stop fitting with a thread, preferably with a stop on a lab analog, so that the lab analog is to be arranged in the model in a positionally fixed manner.

Such a model supplies a basis for the use of a rotationally fixed or even positionally fixed construction for production of a high-quality dental prosthesis.

This may be provided in that a mating lock-in-position is provided in the recess, engaging in a lock-in-position on the lab analog and holding the lab analog in a fixed position.

This also serves so that a lab analog, which is inserted into the recess in the model, can be fixed better and more accurately.

The object of the invention is also achieved by a lab analog for producing a dental prosthesis, in particular for performing one of the methods described here, comprising a region for insertion into a recess in a model of a jaw and a head part for mounting the dental prosthesis, wherein the region is cylindrical or conical in shape and has a one-point or multi-point axis of rotational symmetry about the longitudinal axis of the region, so that the lab analog is to be arranged in a rotationally fixed manner in a recess with a fitting shape, or the region comprises an outside thread, preferably an outside thread with a stop, so that the lab analog is to be arranged in a recess with a fitting internal thread in a fixed position.

Such a lab analog results in an implementation of the invention in particular when it is used together with a model according to the invention. Due to the deviation from rotational symmetry about the longitudinal axis of the region of the lab analog that is inserted, this ensures that the dental prosthesis, which is mounted on the head part/the top part of the lab analog, will always be mounted in the correct position relative to the model of the jaw and will also be used later in the correct angle with respect to the longitudinal axis of the implant in the patient's oral cavity. The same argument may also be used with respect to the advantages of the nonrotationally symmetrical recess in the model of the jaw.

It is possible to provide here that the lab analog comprises a lock-in-position for engaging in a mating lock-in-position in the recess, which holds the lab analog in the recess in a positionally fixed manner.

This again serves to improve the fixation of the lab analog in the model of the jaw and thus to improve the quality of the dental prosthesis.

Furthermore, it is possible to provide that the lab analog has a recess in the longitudinal direction.

Such a recess is suitable for implementation of an implant having a particularly simple mount with a single-point or multi-point rotational symmetry about the longitudinal axis which is easy to use but can also be removed again from the model.

According to another embodiment of the invention, it is possible to provide that the lab analog comprises fastening means for fastening a mount or an abutment.

The dental prosthesis may be mounted on the mount or abutment fixed in the lab analog. This stabilizes the mounting situation.

Furthermore, it is possible to provide that the lab analog comprises undercuts for accommodating a cement in this region, so that the lab analog can also be used bifunctionally with a cementing technique.

Such a lab analog can be used not only with a method according to the invention but may also be used for the traditional methods for producing a dental prosthesis, in which the lab analog is cemented in the model and the undercuts serve to ensure that the cement will form a tight bond with the lab analog. Such lab analogs can then be used universally, so that a single product line is sufficient to supply the market.

The object of the invention is also achieved by a device for producing a model of a jaw for implementation of a method according to the invention as already described, wherein the device comprises a computer for constructing a virtual three-dimensional model of a jaw and a memory unit, wherein data for constructing the model is saved in the memory unit, and at least one shape of at least one recess is saved in the memory unit, where the shape of the recess in each case corresponds to the external shape of at least one region of a lab analog, and the proper position and/or location of the recess can be calculated by computer and/or can be selected by the user and can be added to the virtual three-dimensional model, where the device comprises a production machine that can be controlled by the computer for producing the model or it can be connected to such a production machine.

The use of computers for implementing methods according to the invention is particularly suitable because new methods for producing such models are already being used with computer assistance, so that only a simple addition to the software together with the data pertaining to the surfaces of the recesses and/or the lab analogs need be recorded to achieve an improvement in the dental prosthesis produced.

It is possible to provide here that several shapes of different recesses are saved in the memory unit, and a recess can be selected by means of an input device and/or the recess may be preselected by the computer, depending on the data for creating the model, and in particular the recess may be selected from a preselection by the computer of lab analogs that fit the recesses.

One possible use of various lab analogs and the selection of a particularly suitable lab analog opens up the possibility for a further improvement in the final result produced.

The present invention is based on the surprising finding that when using modern methods such as “rapid prototyping” and/or stereolithographic methods for producing models of jaws, an improvement in the quality of the dental prosthesis is possible if lab analogs with regions for introduction into the models not having a circular cross section are used and this symmetry is also achieved by the recess in the model into which the lab analog is inserted. Through various measures according to the invention, it may then be possible to arrange the lab analog in a particularly accurate position, i.e., in a rotationally fixed or even positionally fixed arrangement in the model.

Furthermore, the fitting recess may be created in the model of the jaw immediately on creation of the model if the surface required for the recess is immediately integrated into a virtual model and the model is produced immediately in production. If both are performed in one working step, the model need not be constructed first, to then abrade material again to create the recess. Furthermore, a particularly well-fitting recess with a fitting lab analog may also be selected directly if a plurality of different lab analogs and the recesses fitting them have been saved and are thus available for selection.

### BRIEF DESCRIPTION OF THE DRAWINGS

Exemplary embodiments of the invention will now be illustrated on the basis of four figures that are represented schematically, although the invention is not limited to these. In addition, one figure also shows a lab analog according to the prior art. These figures show:

FIG. 1: a schematic cross-sectional view of a lab analog according to the prior art;

FIG. 2: a schematic perspective view of a lab analog according to the invention;

FIG. 3: a schematic perspective view of a second lab analog according to the invention;

FIG. 4: a detail of a schematic cross-sectional view of a model according to the invention of a jaw with the lab analog inserted; and

FIG. 5: schematic cross sections through three different lab analogs according to the invention perpendicular to their longitudinal axis.

FIG. 1 shows a schematic cross-sectional view through a lab analog 1 according to the prior art, where its longitudinal axis appears horizontally at the center of the cross section. The lab analog 1 comprises a head part 2 and a rear region 3, which can be inserted into the model of a jaw. The head part 2 serves to mount the actual dental prosthesis (not shown) on its head part 2. To do so, the lab analog 1 is implanted in a model of a patient's jaw, so that the dental prosthesis to be constructed fits the situation in the patient's oral cavity. The lab analog 1 is therefore inserted into the model and integrated into the plaster model there. In order for the plaster to fix the lab analog 1 well, undercuts 4 are provided in the rear region 3, filling up with plaster and thus ensuring a stable connection of the lab analog 1 with the model. The lab analog 1 has a cylindrical geometry with a circular base face, i.e., all the cross sections are circular and perpendicular to the longitudinal axis of the lab analog 1 (i.e., perpendicular in the plane of the image according to FIG. 1).

Such lab analogs 1 as those shown in FIG. 1 are also used to create dental prosthesiss when using plastic models. Such plastic models are constructed by scanning the patient's oral cavity and/or the affected part of the oral cavity, for example, and then creating the plastic model in an automated process. For example, stereolithography may be used to shape such models.

However, with a dental prosthesis constructed in this way, the problem may arise that it does not fit precisely with the implantation situation in the patient's oral cavity. To do so, as part of the present invention, it has been found that lab analogs 1 can be rotated about their longitudinal axes in the recesses in the model because of their rotational symmetry (an imaginary horizontal line at the center of the section through the lab analog 1 in FIG. 1), so that such deviations may occur in creation of the dental prosthesis.

FIG. 2 shows a schematic perspective view of a lab analog 11 according to the invention, which solves this problem. The lab analog 11 comprises a head part 12 and a cylindrical region 13, which can be inserted into the plastic model. The cylindrical region 13 has a cylindrical geometry with a noncircular base area. The lateral surface of the cylinder has an elongated groove 14, breaking the round symmetry of the cylindrical region 13. The cylindrical region 13 of the lab analog 11 therefore has a single point rotational symmetry about the axis of the cylinder. In other words, the cylindrical region 13 can be converted back to its starting state only by rotation of 360° about this axis of the cylinder. As a result the lab analog 11 can be inserted into a recess in a model of the jaw (not shown) only in one position. Therefore the position of the lab analog 11 is fixed rotationally.

A dental prosthesis (not shown) which is constructed on a lab analog 11 fixed in this way is then placed precisely at the same angle in the patient's oral cavity because the head part 12 of the lab analog 11 has exactly the same shape as the head part of the actual dental implant. In the production of the dental prosthesis, the dental prosthesis is always held in the same position in the model and cannot twist or rotate during its production. The head part 12 of a lab analog 11 according to the invention may also advantageously deviate from rotational symmetry. However, all other head parts 12, which currently appear with the dental implants available on the market, may be implemented. A drill hole with an inside thread or another fastening means (not shown) may be provided in the head part, to which an abutment can be attached.

FIG. 3 shows a schematic perspective view of a second lab analog 11 according to the invention, wherein the lab analog 11 here has a consistently cylindrical symmetry with a recess 14. The top side 12 here is the head part 12 of the lab analog 11 and a region which can be introduced into a model of a jaw here may be the lab analog 11 along its entire length. The lab analog 11 may be inserted in precisely one position into a recess in a model of a jaw with a suitably shaped recess. The recess forms the negative of the lab analog 11 but need not have the same height. Instead of a cylindrical lab analog 11, a conical lab analog, which tapers in the direction away from the head part 12, may also be used.

FIG. 4 shows a schematic cross-sectional view of a detail of a model 20 according to the invention of a jaw having a lab analog 21 according to the invention inserted into it. A mount 22, which is attached to the lab analog 21 by fastening means 23, is arranged on the top side of the lab analog 21. The dental prosthesis may be placed on the mount 22. The lab analog 21 is introduced into a recess in the model 20 along its longitudinal axes. The lab analog 21 is cylindrical in shape and has an outside thread 25.

The model 20 comprises a jaw saddle 26 and teeth 27 and/or models thereof. The model 20 is made of plastic and was constructed by using a stereolithographic method.

The opposing jaw part (not shown) is also part of the model 20 to be able to represent the situation in chewing and/or with the mouth closed. The model 20 of the jaw thus does not continue only to the right and left, as indicated with dashed lines.

The model 20 comprises a recess in the shape of a cylindrical hole at a location between the teeth 27. An inside thread 28 is provided on the inside walls of the recess, fitting the outside thread 25 of the lab analog 21. The thread 25, 27 or at least one of threads 25, 27 is closed with a limit stop 29. The limit stop 29 serves to define the position of the lab analog 21 in the model 20. This secures the precise position of the lab analog 21 in the model 20, i.e., so that it is fixed both rotationally and positionally.

For a lab analog 11, as shown in FIG. 2 or 3, the recess would be constructed in a suitable model as a cylindrical hole with a protrusion, which engages in the longitudinal groove 14 and thus holds the lab analog 11 in a rotationally fixed position. The preference of this structure can be seen in the fact that the lab analog 11 can be removed quickly while the lab analog 21 according to FIG. 4 can be fixed better and more accurately.

An exemplary embodiment of a method according to the invention is explained below. The patient's oral cavity is measured to construct a fitting dental prosthesis. To do so, a three-dimensional picture of the oral cavity and/or in particular the respective part of the jaw is recorded. This data is saved and processed in the computer memory.

A virtual three-dimensional CAD model of the jaw or part of the jaw is calculated from this data in a computer. Various recesses, which are assigned to various lab analogs 11, 21, are saved in the computer memory. The computer calculates how the various recesses can be arranged in the model 20. The most stable or most reasonable variant is selected or the most stable or most reasonable variant is presented as a suggestion on a display device, using as the criterion, for example, the thickness of the wall of the model 20 in the area of the recess in the jaw saddle 26 for the various recesses, or which lab analog 11, 21 is the most suitable for the position in the jaw.

Alternatively, the user may select the recesses he considers to be the most suitable of all the available saved recesses. It is also possible to stipulate that the computer will indicate by calculation when a selected recess is impossible or inappropriate, i.e., for example, if it does not appear stable enough. Likewise, only one possible shape of a recess may be saved for a certain type of lab analog 11, 21.

Next, the selected recess or the only predefined recess is combined with the virtual model of the jaw by means of an input device. The recess is therefore calculated as the surface of the virtual model at the location in the virtual model of the jaw where the dental implant is located in the patient's jaw. Then an actual model 20 is created from the new virtual model using known methods, for example, the “rapid prototyping” method. Stereolithographic methods in particular are suitable for this purpose. The computer is therefore connected to a manufacturing machine with which such methods can be implemented.

The lab analog 11, 21 assigned to this recess can be inserted into the recess in the model 20 thus constructed. With respect to FIG. 4, the lab analog 21 may be screwed into the recess of the model 20. The actual dental prosthesis can be constructed in a realistic environment on the mount 22 and/or the abutment 22 of the lab analog 11, 21. Whenever the lab analog 11, 21 is removed from the model 20 or inserted again, it will always be in the same position in the model 20 of the jaw. This makes it possible to ensure that the dental prosthesis will have exactly the correct shape. Furthermore, the dental prosthesis is also arranged in the same position in the patient's oral cavity on the actual dental implant so that a particularly good fit is ensured.

FIG. 5 shows schematic cross-sectional views of the cross sections of four different regions of lab analogs that are provided to be introduced into jaw models. The regions are cut along the longitudinal axis. The first three cuts show a circular base with one or two recesses, which break the rotational symmetry about the longitudinal axis. All the regions of the lab analogs that are shown thus have a single-point rotational symmetry about the longitudinal axis. These regions may be either cylindrical or conical.

If, instead of that, a lab analog having a region with a hexagonal cross section is used, then the region and/or the recesses will have a six-point rotational symmetry; in other words, the region and the surface of the recess one into the other geometrically by six different rotations about the longitudinal axis of less than or equal to 360°. A rectangular or elliptical cross section would lead to a two-point symmetry.

The fourth schematic cross-sectional view according to FIG. 5 shows a lab analog having a region with a triangular cross section, i.e., with a three-point rotational symmetry. The lab analog can be inserted into a recess having the same three-point rotational symmetry.

The features of the invention disclosed in the preceding description as well as the claims, figures and exemplary embodiments may thus be essential for the implementation of the invention in its various embodiments, either individually or in any combination.

### LIST OF REFERENCE NUMERALS

1, 11, 21 lab analog
2, 12 head part
3 rear region
4 undercut
13 cylindrical region
14 longitudinal groove
20 model
22 mount/abutment
23 fastening means
25 outside thread
26 jaw saddle
27 tooth
28 inside thread
29 limit stop

1. A method for producing a three-dimensional model (20) of at least one partial region of a jaw for producing a dental prosthesis, in which a lab analog (11, 21) is arranged in a recess in the model (20), characterized in that
a cylindrical or conical recess is created in the model (20), into which the lab analog (11, 21) is inserted to position the lab analog (11, 21) on the model (20), the recess being created with a single-point or multi-point rotational symmetry about the longitudinal axis of the recess, and a lab analog (11, 21) is used, which has the same rotational symmetry in at least some regions and thus fits into the recess, or a mating thread (28), which fits with a thread (25) on the lab analog (11, 21) is created in the recess.

2. The method according to claim 1, characterized in that
for producing the recess, preferably the model (20) with the recess, a computer is used, in particular a digitization of the patient's oral cavity is used, wherein the shape of the recess is read out of a computer memory unit, and wherein in particular various fitting shapes of the recesses, which are preferably selected by computer and/or by a user by using an input unit are assigned in particular to various lab analogs (11, 21).

3. The method according to any one of claim 1 or 2, characterized in that
a lab analog (11, 21) is used, having the same rotational symmetry as the recess at least in some regions along its longitudinal axis, and preferably fitting accurately in the recess, or with its thread (25) fitting accurately with the mating thread (28) of the recess.

4. The method according to any one of the preceding claims, characterized in that
a CAD-assisted stereolithographic method is used to produce the model (20), and the model (20) is preferably made of plastic, especially preferably being made of a light-curing plastic.

5. The method as recited in claim 4, characterized in that
in the production of the model (20) a certain predefined shape for the recess is preseted, fitting with a certain lab analog (11, 21) and/or a shape for the recess is selected from a plurality of different shapes, which fit with a plurality of different lab analogs (11, 21), wherein the shape is integrated as a recess into a measured virtual digitized model of the jaw, preferably before producing the model (20).

6. The method according to any one of the preceding claims, characterized in that
the lab analog (11, 21) is introduced into the recess with an accurate fit, preferably by plugging it in or screwing it in and/or engaging with a lock-in-position in a mating lock-in-position in the recess.

7. The method according to any one of the preceding claims, characterized in that the model (20) and the recess are produced in one step, wherein preferably the external shape of the model (20) is based on a measurement on the patient, and the shape of the recess is certain predefined.

8. The method according to any one of the preceding claims, characterized in that
a mating thread (28) with a limit stop (29), which fits with a thread (25) on the lab analog (21), is created in the recess in the model (20), wherein the thread (25) of the lab analog (21) preferably also comprises a limit stop (29).

9. A model of a jaw for producing a dental prosthesis, in particular for performing a method according to any one of the preceding claims, comprising a recess for insertion of a lab analog (11, 21), characterized in that
the recess has a cylindrical or conical shape and has a single-point or multi-point axis of rotational symmetry along the longitudinal axis, so that a lab analog (11, 21) having the same rotational symmetry in at least some regions is to be arranged in a rotationally fixed manner in the recess, or a mating thread (28), preferably with a limit stop (29) is provided in the recess and fits with a thread (25), preferably with a limit stop (29) of a lab analog (11, 21), so that the lab analog (11, 21) is to be arranged in a fixed position in the model (20).

10. The model according to claim 9, characterized in that
a mating lock-in-position is provided in the recess, engaging in a lock-in-position on the lab analog (11, 21) and holding the lab analog (11, 21) in a fixed position.

11. A lab analog for producing a dental prosthesis, in particular for performing a method according to any one of claims 1 to 8, comprising a region (13) for insertion into a recess in a model (20) of a jaw and a head part (12) for mounting the dental prosthesis, characterized in that
the region (13) has a cylindrical or conical shape and has a single-point or multi-point axis of rotational symmetry about the longitudinal axis of the region (13), so that the lab analog (11, 21) is to be arranged with a fitting shape in a recess in a rotationally fixed manner, or the region comprises an outside thread (25), preferably an outside thread (25) with a limit stop (29), so that the lab analog (21) is to be arranged in a positionally fixed manner in a recess with a fitting inside thread (28).

12. The lab analog according to claim 11, characterized in that
the lab analog (11, 21) comprises a lock-in-position for engaging in a mating lock-in-position in the recess which holds the lab analog (11, 21) in a fixed position in the recess.

13. The lab analog according to claim 11 or 12, characterized in that
the lab analog (11, 21) has a recess (14) in the longitudinal direction in the region (13).

14. The lab analog according to any one of claims 11 to 13, characterized in that the lab analog (11, 21) comprises fastening means (23) for fastening a mount (22) or an abutment (22).

15. The lab analog according to any one of claims 11 to 14, characterized in that
the lab analog (11, 21) comprises undercuts for receiving a cement in the region (13), so that the lab analog (11, 21) can also be inserted bifunctionally with a cementing technique.

16. A device for producing a model (20) of a jaw for implementing a method according to any one of claims 1 to 8, characterized in that
the device comprises a computer for constructing a virtual three-dimensional model (20) of a jaw and a memory unit, wherein data for creating the model (20) is saved in the memory unit and at least one shape of at least one recess is saved in the memory unit, wherein the shape of the recess corresponds to and is assigned to the outer shape of at least one region (13) of a lab analog (11, 21), and the correct position and/or the position of the recess can be calculated by the computer and/or can be selected by the user and can be added to the virtual three-dimensional model (20), wherein the device comprises a production machine that is controllable by the computer for producing the model (20) or can be connected to such a production machine.

17. The device according to claim 16, characterized in that
multiple shapes of different recesses are saved in the memory unit and a recess can be selected by an input device and/or are preseted by the computer, depending on the data for creating the model (20), wherein in particular the recess can be selected from a computer-determined preselection of lab analogs (11, 21) that fit with the recesses.
